(19) United States
(12) Patent Application Publication
(10) Pub. No.: US 2007/0235255 A1
(43) Pub. Date: Oct. 11, 2007

(54) Combination hunting stand and cart

(76) Inventors: John L. Wallace, Cache, OK (US); David H. Staats, Lawton, OK (US)

Correspondence Address: John E. Vandigriff, 906 Stone Circle Ln, Lewisville, TX, 75056, US

(21) Appl. No.: 11/394,437

(22) Filed: Apr. 3, 2006

(51) Int. Cl. E06C 7/16

(52) U.S. Cl. 182/20; 182/116

(57) ABSTRACT

A combination stand/cart is used in hunting to transport hunting equipment and any game acquired during hunting. The stand/cart is, in a folded conditions used as a card, and as a ladder/hunting station when unfolded. A platform to tree connection is designed to install safely by being moved from behind the tree to the ladder side underneath the platform. The seat rotates 360 degrees on a standpipe, which allows for a slow, discrete, safe turn in order to execute a stable seated shot. The attachable bow, quiver and or rifle holders are mounted to the seat in order to allow immediate use without excessive movement during aiming. The stand can quickly and easily be unfolded from the “load carrier” function to the “ladder tree stand” function. This is accomplished by means of “unfold and pin” at three pivot points; one at the center of the ladder and one at the ladder to platform junction and one at the seat stand pipe.

### FIELD OF THE INVENTION

The invention relates to hunting stands and carts, and more particularly to a foldable combination of a hunting cart and stand.

### BACKGROUND OF THE INVENTION

Hunting stands have been in use for a number of years. Some have been made in combination with other functions, such as carts for moving objects. The following patents are cited to show the back ground of the invention, and are not considered prior art that would prevent the patenting of the present invention.

U.S. Pat. No. 5,295,556 discloses a multipurpose hunter's apparatus convertible between a wheeled cart, a sled, a tree stand, and a free standing deer stand. The apparatus comprises a pair of L-shaped frame members separated by a plurality of rungs to provide a ladder when in the elevated position, or as brace members when used as a transporting device. A unique arrangement of three braces can be used in various configurations to rigidly stabilize the respective arrangement and to provide a load retaining member when transporting game or hunter's equipment. A handle is adaptable to the wheeled carts and the sled arrangements which is adaptable to a snowmobile or an all terrain vehicle. Various members are multipurpose in function such that various devices can be arranged, with a minimal amount of material. The apparatus can be transportable in a boat across open water, and can be arranged to carry the boat between portages. From start to finish of a hunting trip, the apparatus can be figured into a variety of useful orientations as appropriate. Finally, the free standing deer stand can include a tarp disposed thereon to provide a shelter for the hunter which is camouflaged. A hunter can reside in the shelter in either an elevated hunting position or a ground level tent position depending on the need

U.S. Pat. No. 6,860,364 discloses a cart and ladder combination includes a plurality of bars such that a first bar and a second bar are defined. A first coupler is adapted for releasably coupling the first and second bars together in a spaced relationship to each other. A second coupler is adapted for releasably coupling the first and second bars together in a spaced relationship to each other. A wheel assembly is removably attached to the first ends of the first and second bars. A cord member is selectively strung between the first and second bars. The second end of the first bar may be selectively attached to the first end of the second bar to form a ladder.

U.S. Pat. No. 6,550,575 discloses a a combination apparatus for vehicles with or without an open bed comprising an elevated viewing perch or observation stand with a seat, a luggage/personnel carrier/kayak carrier, a pontoon boat, a fishing platform, and a farm plow. The viewing perch can be mounted on an open bed vehicle such as ATV's, trucks or like vehicles and have a ladder-type frame on rear wheels. The frame can be used as a utility trailer for hauling equipment, game or an injured person, and readily converted to an elevated position and used as a viewing or hunting stand. The apparatus can be raised to the elevated position by hand or by a winch, can serve as a tent shelter with bunk-type cots placed inside, and can be wired for lighting, energized by the vehicle's battery.

### SUMMARY OF THE INVENTION

The invention is an elevated stand which is comfortable and safe enough to nap in during long hunts. Comfort is attained by the use of a padded molded seat with lumbar support, armrests, and an attachable headrest. Safety is greatly improved by the chair safety belt inside the molded seat along with lateral ladder leg extensions that broaden the base thus stabilizing the stand.

The platform to tree connection is designed to install safely by being moved from behind the tree to the ladder side underneath the platform. The seat rotates 360 degrees on a standpipe, which allows for a slow, discrete, safe, turn in order to execute a stable seated shot. The attachable bow, quiver and or rifle holders are mounted to the seat in order to allow immediate use without excessive movement during aiming.

This stand can quickly and easily be unfolded from the “load carrier” function to the “ladder tree stand” function. This is accomplished by means of “unfold and pin” at three pivot points; one at the center of the ladder and one at the ladder to platform junction and one at the seat stand pipe.

Additional features include: two “wrap straps”, one “center brace”, and a front mount platform attachment system for safe and quick installation. The mid-ladder connections provide for three different platform elevations. A cable with an adjustable chain system locks the platform to various size trees.

The technical advance represented by the invention as well as the objects thereof will become apparent from the following description of a preferred embodiment of the invention when considered in conjunction with the accompanying drawings, and the novel features set forth in the appended claims.

### BRIEF DESCRIPTION OF THE DRAWINGS

FIG. 1 shows the hunting stand/cart in a folded, transportable condition;

FIG. 2 is an isometric view of the stand/cart in a partially unfolded position;

FIG. 3 is a side view of the stand/cart in a partially unfolded position;

FIG. 4 is an isometric view of the stand/cart in an erect, unfolded position.

### DESCRIPTION OF A PREFERRED EMBODIMENT

The invention is a hunting stand/cart that folds for transporting the hunting stand, and for carrying supplies to a hunting site, and transporting game acquired during hunting. The cart function helps carry large game such as deer.

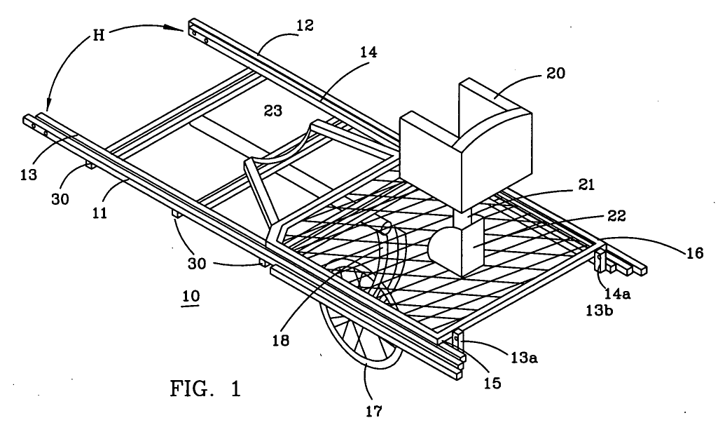

FIG. 1 shows the hunting stand/cart in a folded, transportable condition. The stand/cart 10 has three basic folding section. The first section has side supports 11 and 12. These side supports are movably connected to the second or mid section which includes side supports 13 and 14. The third section supports seat 20 and has side supports 15 and 16 which are moveably connected to side supports 13 and 14. The first two sections have cross members 30 which are spaced between and secured to the side members 11 and 12, and 13 and 14. The side members and cross members form a ladder, when the stand 10 is in use, and a bed/support for the cart when the ladder is folded.

A wheel 17 is attached to the first section by a wheel support 18, and is used to move the stand/cart from one location to another. The first and second sections, where jointed (H), form the handles for the use when the stand/cart is in the cart mode.

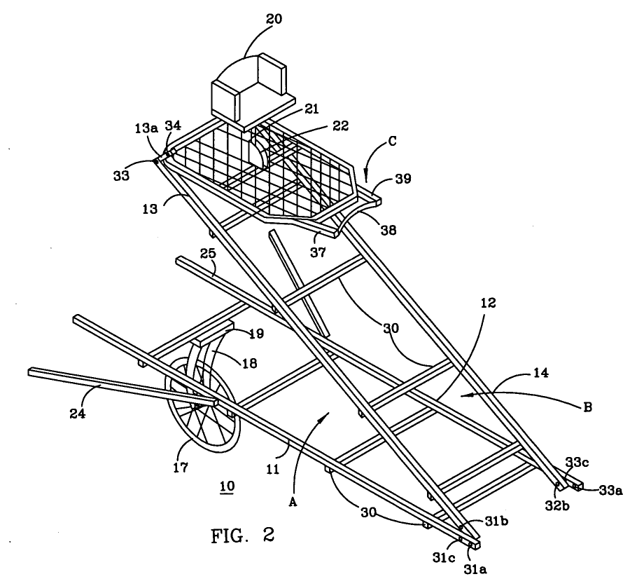

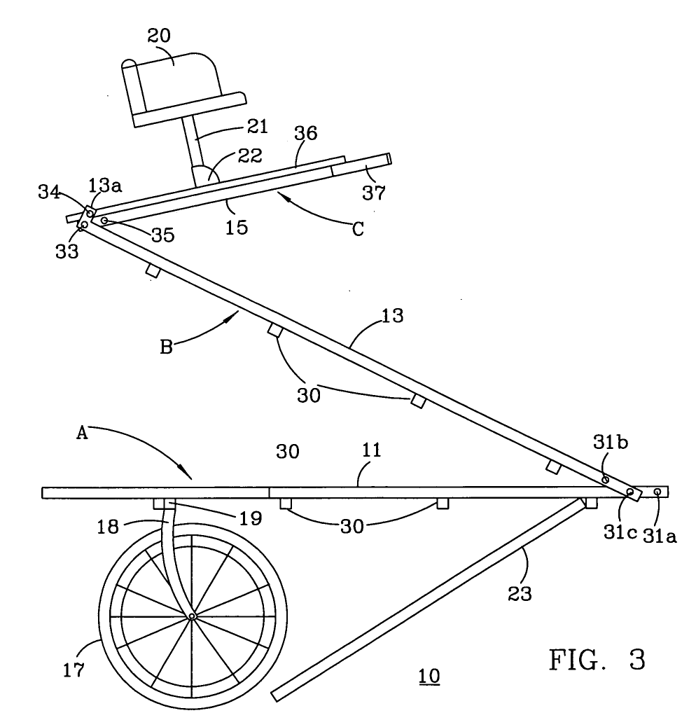

FIG. 2 is an isometric view and FIG. 3 is a side view of the stand/cart 10 in a partially unfolded/raised position. In FIG. 2, the sections are generally identified as follows. Section one is designated “A”, section 2 is designated as “B”, and section 3, the seat section is designation as “C”.

Section A is moveably connected to section B by fasteners 31c and 32c. When in a raised, ladder, position, Section B is secured in an extended/raised position by pins placed in openings 33a and 33b in side members 12 and 14, and in openings 31a and 31b in side members 11 and 13. Similarly, section C is moveably connected to Section B by pin 33 connection side members 13 and 15, and by a pin (not illustrated), connecting side members 14 and 16. Attached to side member 13 is an extension 13a, and there is an extension 14a attached to side member 14. Extensions 13a and 14a are secured by placing a pin (not illustrated) through openings 34, in 13a and 38 in member 16. Extension 14a has an opening not shown) and side member 16 has on opening (not shown) through which a pin may be inserted to secure 14 to 16.

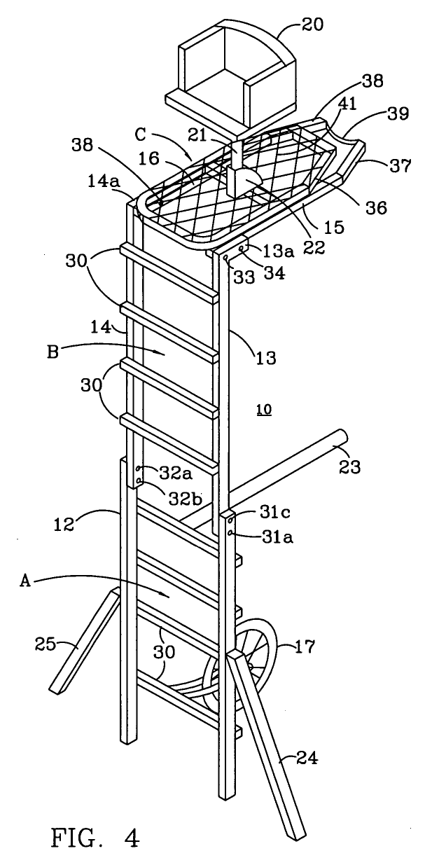

A support 23 extends to a tree when the stand/cart is in an erect stand position. Support 23 may be used to support and stabilize the lower part of the stand 10, and may be secured to a tree by a rope or other means, not illustrated. Support 23 is attached to one of the cross members 30. There are two side supports 24 and 25 which are attached to side members 11 and 12, respectively. These side supports stabilize and help prevent a sideward movement of the ladder when in a raised position. See FIGS. 2 and 4.

Seat 20, mounted on supports 21 and 22, is mounted on a platform 36, which in turn is mounted on Section C. Platform 36 has a wire mesh cover 41. Platform 36 has supports 37, 38 and 39 which may be placed against a tree or pole when the stand/cart is in a raised position. Seat 20 may be rotated on support 21 so that the person in the seat may face any desired direction.

FIG. 3 is a side view of the stand/cart 10. Section A is supported on wheel 17 which is attached to Section A by a cross brace 19 and support 18. Section A includes two side members 11 and 12, and several cross members 30. A support member 23 is attached to one of the cross members 30, and is used to support the stand/cart when in a vertical position against a tree or pole.

Section B is attached to Section A by pins, pin 31c is shown, securing side member 11 to side member 13. When in an erect position, a pin is inserted though openings 31a and 31b to secure the two side members 11 and 13 in the erect extend position. Section B also has a plurality of cross members 30.

Section B is connected to section C b pins. Pin 33 is shown. Each of the side members 13 and 14 of section B has an extension 13a and 14a, respectively. Only extension 13a is shown in FIG. 3. Section B is additional secured to Section C, when in a raised, erect position, by inserting a pin in openings 34 and 35, when aligned. Platform 36 is mounted on Section C, and has supports 22 and 21 on which seat 20 is rotatably mounted.

FIG. 4 shows the cart/stand 10 in a raised, erect position. As illustrated, Section B is attached to Section A and held in the erect position by pins in aligned openings 31a and 31b, and 33a and 33b.

Supports 24 and 25 are positioned outward to provide side support for the stand. Support 23, extending from one of the cross members 30, extends to a tree of pole against which the stand is positioned.

Section C is held in a horizontal position on Section B by the extensions 13a and 14a, which extend outward and are secured to the side supports of Section C. Platform 36 is mounted on Section C, and supports the seat 20. Section C has extension 37, 38 and 39 which are placed against a tree or pole. A rope, cable, or other securing device (not illustrated) may be placed around the tree or pole to secure platform, and the stand, to the tree or pole.

The stand/cart as illustrated in FIG. 4 is used as a hunting station. The hunter climbs up the stand and sits on seat 20 while waiting on game. After the hunting session is over, the stand/cart, is folded to form the cart on which to carry hunting equipment and game back to the hunter's vehicle.

What is claimed:

1. A combination stand/cart is used in hunting to transport hunting equipment and any game acquired during hunting; comprising:
a plurality of sections pivotally connected to each other, each section having a pair of side supports and a plurality of spaced apart cross members attached to the side supports;
at least one wheel attached to one of said sections, and a seat attached to another of said sections.

2. The stand/cart according to claim 1, wherein when at least two of the plurality of sections are extended, they form a ladder.

3. The stand/cart according to claim 1, wherein in a stand configuration, two sections in an extended position form a ladder, and a third section forms a platform on which said seat is mounted.

4. The stand/cart according to claim 1, wherein in a cart configuration, the sections are folded to form a platform supported by at least one wheel attached to one of said sections, and two joined ends of two of the sections serve as handles for moving the cart around.

5. The stand/cart according to claim 1, wherein said seat is removable and rotatably mounted on one of said sections.

6. The stand/cart according to claim 1, including two side supports, one attached to each side of one of the sections.

7. The stand/cart according to claim 1, including a brace attached to one of said cross members.

8. A combination stand/cart used in hunting to transport hunting equipment, and any game acquired during hunting; comprising:
first, second and third sections pivotally connected to each other, each section having a pair of side supports and a plurality of spaced apart cross members attached to the side supports; and
at least one wheel attached to said first section, and a seat attached to said third section.

9. The stand/cart according to claim 8, wherein when at least two sections are extended, they form a ladder.

10. The stand/cart according to claim 8, wherein in a stand configuration, the first and second sections in an extended position form a ladder, and the third section forms a platform on which said seat is mounted.

11. The stand/cart according to claim 8, wherein in a cart configuration, the sections are folded to form a platform supported by the wheel attached to one of said first section, and two joined ends of two of the first and second sections serve as handles for moving the cart around.

12. The stand/cart according to claim 8, wherein said seat is removable and rotatably mounted on said third section.

13. The stand/cart according to claim 8, including two side supports, one attached to each side of the first section.

14. The stand/cart according to claim 1, including a brace attached to one of said cross members.

15. A combination stand/cart used in hunting to transport hunting equipment and any games acquired during hunting; comprising:
first, second and third sections pivotally connected to each other, each section having a pair of side supports and a plurality of spaced apart cross members attached to the side supports;
at least one wheel attached to said first section, and a seat attached to said third sections; and
two side supports, one attached to each side of the first section.
